(19) United States
(12) Patent Application Publication
(10) Pub. No.: US 2025/0006052 A1
(43) Pub. Date: Jan. 2, 2025

(54) SYSTEMS AND METHODS FOR AUTONOMOUS VEHICLE SELECTION AND ROUTING USING ARTIFICIAL INTELLIGENCE

(71) Applicant: State Farm Mutual Automobile Insurance Company, Bloomington, IL (US)

(72) Inventors: Aaron Williams, Congerville, IL (US); Seth Corin, Cumming, GA (US)

(21) Appl. No.: 18/623,797

(22) Filed: Apr. 1, 2024

Related U.S. Application Data
(60) Provisional application No. 63/510,593, filed on Jun. 27, 2023.

(51) Int. Cl. G08G 1/0967; G06F 40/20; G07C 5/00; G07C 5/08; G08G 1/0968

(52) U.S. Cl. CPC G08G 1/096725; G06F 40/20; G07C 5/008; G07C 5/0808; G08G 1/096811

(57) ABSTRACT

A computer system may be provided. The computer system may include at least one processor. The at least one processor may be programmed to: (i) receive, from a user device, a transportation request including an origin, a destination, and at least one good or person to be transported; (ii) select, based upon the transportation request using an AI model, an AV of a plurality of candidate AVs in communication with the server computing device, wherein the AI model is trained using historical transportation records including historical transportation data associated with historical transportation; (iii) generate, based upon the transportation request using the AI model, a route for the AV; and/or (iv) transmit route data to the selected AV, wherein the route data causes the selected AV to travel the generated route.

### CROSS-REFERENCE TO RELATED APPLICATIONS

This application claims priority to U.S. Provisional Patent Application No. 63/510,593, filed Jun. 27, 2023, the entire contents and disclosures of which are hereby incorporated herein by reference in its entirety.

### FIELD OF USE

The present disclosure relates to autonomous vehicles (AVs), and more particularly, to computer-based systems and methods for selecting and routing AVs for transporting passengers, good, and/or materials using artificial intelligence (AI).

### BACKGROUND

An AV, also known as a “self-driving car”, is a vehicle that is capable of operating automatically without human input. AVs may operate at varying levels of autonomy, such as through a relatively low-level-autonomy system, sometimes referred to as an advanced driver-assistance system (ADAS) which is currently utilized in the automotive industry, or a high-level-autonomy system, sometimes referred to as an automatic-driving system (ADS) which is utilized in “self-driving” vehicles. While AV technology is advancing rapidly, developing a fully autonomous vehicle is an interdisciplinary challenge that requires further advancement in several related technologies.

AVs may be used to transport goods or persons from place to place. Owners and operators of individual AVs and fleets of AVs generally benefit from maximizing a number of deliveries and efficiency while reducing risk, liability, cost, downtime, and damage to brand among other factors. However, determining which AV to use for a trip and/or delivery, and determining which route to use generally requires manual processes to select which AV to use for a trip and/or delivery and determining which route to use based upon, for example, riders, packages, materials, ranges, locations/areas, time of pickup/delivery, risks/liability, and customer profiles.

Further, conventional techniques may include inefficiencies, ineffectiveness, encumbrances, and/or other drawbacks as well.

### BRIEF SUMMARY

The present embodiments may relate to, inter alia, systems and methods for automated AV selection and/or routing using an AI model. In the exemplary embodiment, the server computing device may receive, from one of the user devices, a transport request including an origin, a destination, and at least one good or person to be transported. For example, the transportation request may indicate the identities of individuals or types of goods to be transported, so that an appropriate AV may be selected to transport the good or person from the specified origin to the specified destination. Based upon the transportation request using an AI model, the server computing device may select one of the AVs in communication with the server computing device and generate a route for the AV to transport the good or person from the origin to the destination. The server computing device may generate and/or train the AI model to select AVs and generate routes based upon data input by the user and other data that may be retrieved by the server computing devices. The AI model may be trained using historical transportation records, which may include historical trips and/or deliveries and data associated with the historical transportation. The AI model may determine factors such as a distance, duration, cost, and/or safety of using various potential AVs and/or potential routes, which may be used to select one or more AVs and/or routes to be used for the requested trip and/or delivery. In some embodiments, the AI model may be further configured to determine a cost associated with a trip and/or group of trips.

In one aspect, a computer system for AV selection and/or routing using an AI model may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computer system may include at least one memory and at least one processor in communication with the at least one memory. The processor may be programmed to: (i) receive, from a user device, a transportation request including an origin, a destination, and at least one good or person to be transported; (ii) select, based upon the transportation request using an AI model, an AV of a plurality of candidate AVs in communication with the server computing device, wherein the AI model is trained using historical transportation records including historical transportation data associated with historical transportation; (iii) generate, based upon the transportation request using the AI model, a route for the AV; and/or (iv) transmit route data to the selected AV, wherein the route data causes the selected AV to travel the generated route. The computer system may perform additional, less, or alternate functionality, including that discussed elsewhere herein.

In another aspect, a server computing device may be provided. The server computing device may include at least one processor in communication with at least one memory device and with a user device. The at least one processor may be configured to (i) receive, from the user device, a transportation request including an origin, a destination, and at least one good or person to be transported; (ii) select, based upon the transportation request using an AI model, an AV of a plurality of candidate AVs in communication with the server computing device, wherein the AI model is trained using historical transportation records including historical transportation data associated with historical transportation; (iii) generate, based upon the transportation request using the AI model, a route for the AV; and/or (iv) transmit route data to the selected AV, wherein the route data causes the selected AV to travel the generated route. The server computing device may perform additional, less, or alternate functionality, including that discussed elsewhere herein.

In another aspect, a computer-implemented method for AV selection and/or routing may be provided. The computer-implemented method may be performed by a server computing device including at least one processor in communication with at least one memory device and with a user device. The computer-implemented method may include (i) receiving, from the user device, a transportation request including an origin, a destination, and at least one good or person to be transported; (ii) selecting, based upon the transportation request using an AI model, an AV of a plurality of candidate AVs in communication with the server computing device, wherein the AI model is trained using historical transportation records including historical transportation data associated with historical transportation; (iii) generating, based upon the transportation request using the AI model, a route for the AV; and/or (iv) transmitting route data to the selected AV, wherein the route data causes the selected AV to travel the generated route. The computer-implemented method may include additional, less, or alternate functionality, including that discussed elsewhere herein.

In another aspect, at least one non-transitory computer-readable storage media having computer-executable instructions embodied thereon may be provided. When executed by a server computing device including at least one processor in communication with at least one memory device and with a user device, the computer-executable instructions may cause the at least one processor to (i) receive, from the user device, a transportation request including an origin, a destination, and at least one good or person to be transported; (ii) select, based upon the transportation request using an AI model, an AV of a plurality of candidate AVs in communication with the server computing device, wherein the AI model is trained using historical transportation records including historical transportation data associated with historical transportation; (iii) generate, based upon the transportation request using the AI model, a route for the AV; and/or (iv) transmit route data to the selected AV, wherein the route data causes the selected AV to travel the generated route. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary computer system in accordance with an exemplary embodiment of the present disclosure.

FIG. 2 depicts an exemplary client computing device that may be used with the computer system illustrated in FIG. 1.

FIG. 3 depicts an exemplary server system that may be used with the computer system illustrated in FIG. 1.

FIG. 4 depicts an exemplary AV that may be used with the computer system illustrated in FIG. 1.

FIG. 5A is a flowchart that illustrates an exemplary computer-implemented method for automated AV selection and routing using AI.

FIG. 5B is a continuation of the flowchart showing the exemplary computer-implemented method shown in FIG. 5A.

FIG. 5C is a continuation of the flowchart showing the exemplary computer-implemented method shown in FIGS. 5A and 5B.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for automated route generation using an AI model. In the exemplary embodiment, the systems and methods may be performed by a server computing device, a bank of server computing devices, and/or other computing devices, which may be in communication with one or more client devices (sometimes referred to herein as “user devices,” which may be personal computers, tablet computers, mobile telephones, and/or other such devices) and one or more autonomous vehicles (AVs).

In the exemplary embodiment, the server computing device may receive, from one of the user devices, a transport request including an origin, a destination, and at least one good or person to be transported. For example, the transportation request may indicate the identities of individuals or types of goods to be transported, so that an appropriate AV may be selected to transport the good or person from the specified origin to the specified destination. The transportation request may be submitted, for example, via a user interface on a user device (e.g., via a web page or application), as a natural language input, and/or generated based upon existing records (e.g., smart contracts, emails, text messages, etc.). Based upon the transportation request using an artificial intelligence (AI) model, the server computing device may select one of the candidate AVs in communication with the server computing device and generate a route for the AV to transport the good or person from the origin to the destination. In alternative embodiments, the systems and methods may be applied to select and/or generate routes for conventional vehicles and/or transportation devices (e.g., non-autonomous vehicles).

The server computing device may generate and/or train the AI model, which may be used to select AVs and generate routes based upon data input by the user (e.g., the origin, destination, and goods or persons to be transported) and other data that may be retrieved by the server computing devices (e.g., geographic data including maps and availability of AVs at given locations, contextual data such as traffic, weather, and/or road conditions, and user profile data indicating preferences of the user). The AI model may be trained using historical transportation records, which may include historical trips and/or deliveries and data associated with the historical transportation (e.g., historical goods or persons transported, destinations, routes, types of transportation and/or AVs used, telematics data collected during the trip, costs, user feedback, and/or events such as collisions, damage, and/or injuries occurring during the trip). The AI model may determine factors such as a distance, duration, cost, and/or safety of using various potential AVs and/or potential routes, which may be used to select one or more AVs and/or routes to be used for the requested trip and/or delivery. In some embodiments, the AI model may consider, as constraints, parameters defined by owners or operators of the candidate AVs in selecting the AV. For example, an operator may specify conditions under which a candidate AV controlled by the operator may automatically not selected, such as a maximum risk and/or insurance cost threshold certain types of goods deemed by the operator to be too dangerous, and/or certain passengers that have a history of dirtying and/or causing damage to vehicles. In some embodiments, the AI model may be further configured to determine a cost associated with a trip and/or group of trips, and the server computing device may facilitate billing or payment for the associated transportation services (e.g., costs associated with renting and/or using AVs owned by other entities and/or insurance costs associated with the transportation services).

In some embodiments, the server computing device may collect telematics data (e.g., image or camera data, acceleration, cornering, braking, position, velocity, orientation, speed, location, GPS location or other GPS information, etc.) during trips. Such telematics data may be generated by sensors of AV or of devices that may be onboard the AV (e.g., telematics fobs or user devices) that may provide telematics data. This data may be sued to determine changes in condition of AV before and after the trip and/or delivery and for tracking the AV in real time during the trip and/or delivery. Such telematics data, along with historical events data relating to events (e.g., accidents, damage to goods, or injuries to persons) occurring during the trips, may be used to train the AI model, for example, to determine a safety and/or generate a risk or loss score (e.g., associated with a likelihood of an injury or financial loss occurring) for a given AI and/or given route carrying a particular type of goods or passenger. In some embodiments, the risk score may be used to determine an insurance cost for a trip and/or to select AVs and/or generate routes that prioritize safety and/or reducing risk.

### Retrieving Input Data

In the exemplary embodiment, the server computing device may be configured to retrieve input data that may be used to select an AV and/or generate a route for a received transportation request. Certain input data (e.g., an origin and/or desired destination, who is being transported or what type of good is being transported, pricing data, traffic data, weather data, and/or road condition data) may be specific to a given trip, while other input data (e.g., user preferences, geographic data, historical trend data) may apply generally to multiple trips and/or deliveries. In some embodiments, each user may have a user profile (e.g., associated with a user login account), which may include information associated with the respective user.

In the exemplary embodiment, the server computing device may receive an origin, a destination, and data describing who is being transported or what type and how much of a good is being transported for a requested trip and/or delivery. For example, the server computing device may cause an application executing on the user device to prompt a user to input an origin, destination, and who and/or what is to be transported. In some embodiments, the user may further input (e.g., via the mobile application) certain waypoints, or intermediate points between the origin and destination through which the route must pass. In some embodiments, the user may specify a time for the trip and/or delivery (e.g., via the application). For example, the user may request the trip and/or delivery immediately, or may specify a future time for the trip and/or delivery. The future time may be a single instance or may be recurring (e.g., daily or weekly). In some embodiments, the user may be prompted by the application to log into the user's login account prior to receiving a transportation request from the user. In some embodiments, the application may include a chatbot functionality, through which the user may request a route and/or other information using text and/or natural language. Such text and/or natural language inputs may be analyzed using AI and/or chatbot programs (e.g., ChatGPT), which in some embodiments may generate text and/or natural language responses to be presented through the application. In some embodiments, the transportation request may be generated based upon preexisting records, such as by being generated based upon data retrieved from a smart contract stored, for example, in a blockchain format, or another record including data relevant for generating the transportation request (e.g., emails, text messages, invoices, etc.).

In some embodiments, the server computing device may further retrieve geographic data based upon which the AV may be selected and/or the route may be generated. The geographic data may include data describing topography, locations or thoroughfares such as highways, roads, bike paths, trails, and sidewalks, mass transit routes, safety statistics (e.g., rates of traffic collisions and/or crime), and zones in which certain transportation services may be available. The geographic data may be retrieved from a database, the Internet (e.g., from third-party mapping services, such as Google Maps), and/or other sources capable of providing such data, and may be periodically or continually updated to reflect a current state.

In some embodiments, the server computing device may further retrieve contextual data, or data describing current or real-time conditions, based upon which the AV may be selected and/or the route may be generated. The contextual data may include data describing traffic conditions, road conditions (e.g., construction), major events that may affect traffic flow (e.g., locations of conventions, concerts and/or sporting events), weather, time of day, time of year, or other conditions that may affect travel. The geographic data may be retrieved from a database, the Internet (e.g., from third-party mapping services, such as Google Maps), and/or other sources capable of providing such data, and may be periodically or continually updated (e.g., in real time) to reflect current conditions. As described in further detail below, the server computing device may be configured to update generated routes in real time (e.g., after travel has started) if contextual data indicates that conditions have changed from when the route was initially generated.

In some embodiments, the server computing device may further retrieve user profile data. The user profile data may include preferences to use certain types of transportation, age, health information, demographic information, historical trips and/or deliveries and patterns of trips and/or deliveries, historical usage of different AVs and/or types of AVs, frequently visited locations, locations frequently delivered to and/or from, historical accident information, historical events and/or claims (sometimes referred to herein as “event data”), and/or preferred billing option. The user profile data may be retrieved from a database, the Internet, and/or other sources capable of providing such data. For example, user profiles including user profile data may be stored for each user in the database. The user profile information may be entered by the user (e.g., via preferences and/or settings interface of the mobile app), automatically compiled based upon historical trips and/or deliveries, and/or automatically retrieved from other data sources (e.g., insurance, financial, and/or transportation service accounts linked to the user profile and/or associated with the user). In some embodiments, the application may initially autofill the user profile with automatically compiled user profile information and allow the user to manually make changes to the information.

The user profile data may further include historical telematics data (e.g., acceleration, cornering, braking, position, velocity, orientation, speed, location, GPS location or other GPS information, etc.) associated with previous trips taken by the user. The telematics data may be collected by sensors of the AV, user devices, and/or telematics devices communicatively linked to the AV during trips (e.g., via Bluetooth and/or another wired or wireless communication protocol), and/or transportation service accounts (e.g., rideshare accounts and/or accounts associated with delivery and/or shipping services) linked to the user profile that may collect and/or store telematics data during trips. The user profile may further include user feedback from previous trips. For example, the application may prompt the user to rate a trip or delivery upon completion of the trip or delivery, and over time, the server computing device may identify aspects of a trip or delivery that are preferred by the user based upon the submitted ratings.

### Building an Artificial Intelligence Model

In the exemplary embodiment, the server computing device may be configured to generate an AI model, that may be used to select AVs, generate routes, and/or determine other metrics associated with selected AVs and routes (e.g., costs and/or amount of risk) based upon input data. In some embodiments, the server computing device may generate and/or train the AI model using a training dataset that includes one or more training variables and/or model parameters, such as historical transportation data (e.g., data associated with previous trips and/or deliveries performed by AVs), historical geographic data, historical contextual data, historical user profile data (e.g., including historical preferences of users), and/or historical event data (e.g., data relating to incidents and/or claims associated with previously completed trips or deliveries).

In other embodiments, the server computing device may generate the AI model in a different format. For example, the AI model may be a function for receiving data (e.g., a desired destination, on origin, passenger and/or goods to be transported, geographic data, contextual data, and user profile data) and generating an output for selecting an AV and determining a route from the specified origin to the specified destination.

The server computing device may be configured to generate the AI by analyzing historical trip and/or delivery records including historical trip and/or delivery data (e.g., historical origins, destinations, passengers and/or goods transported, routes, AVs and/or types of AVs used, telematics data, costs, user feedback, and/or events such as collisions, damages, and/or injuries occurring during the trip) associated with historical trips and/or deliveries. The server computing device may be configured to perform a statistical analysis of the historical trip and/or delivery records to generate the AI model. For example, for an aspect of a historical trip and/or delivery (e.g., origins, destinations, passengers and/or goods transported, routes, types of transportation used, telematics data, costs, user feedback, and/or events such as collisions and/or injuries that occurred during the trip), the server computing device may identify historical trip and/or delivery records associated with the aspect and generate model parameters (e.g., by identifying other parameters held in common among the identified historical trip and/or delivery records). For example, the server computing device may identify features correlated with a particular historical pattern of a user traveling between a certain origin and destination or similar goods being delivered between a certain origin and destination, and which routes and types of AV were used for these historical trips. In other embodiments, the server computing device may be configured to perform a different analysis that is suitable to generate the AI model.

The AI model may be associated with and/or include a parametric engine. The parametric engine represents a relationship between input data such as training variables and/or predicted outputs. The training variables may be parameterized allowing the parametric engine to be tuned to generate accurate outputs. Parameterized training variables may be weighted using weighting coefficients. The parametric engine may be tuned to determine a magnitude and/or a direction of the weighting coefficients. Tuning may include iteratively using the parametric engine to generate model outputs that correspond to an actual event, such as a historical trip and/or delivery, while adjusting the magnitude and direction of the weight coefficients until the error between the model output and the actual event is reduced to an acceptable level. Tuning may be performed in addition to, and/or in combination with, training the model using historical data.

The parametric engine may use the weighted coefficients to rank an importance or influence of a model training variable. For example, the greater the weighting factor the greater the importance the server computing device will associate with that variable when tuning the model. Likewise, the smaller the weighting factor the lesser the importance that the server computing device will associate with the variable when tuning the model. In some embodiments, the server computing device may weight variables associated with the historical trip and/or delivery records greater than any other model training variables.

In some embodiments, the server computing device may use a reduced number of training variables (e.g., one or more training variables) that have the greatest weighting factors (e.g., the variables that are ranked with the most importance). The reduced and more focused training dataset, including the training variables with the greatest weights, decreases computational load and will have decreased model training time allowing the model to be more quickly updated as more historical trip and/or delivery records are created and added to the subset training dataset. The server computing device may generate a training dataset including less than a particular number (e.g., five or three) model training variables, for example.

### Selecting AV for Trip or Delivery Using AI Model

In the exemplary embodiment, the server computing device may be further configured to select one or more AVs from a group of candidate AVs for a requested trip or delivery using the generated AI model. The AI model may be configured to output a specific AV for performing the trip or delivery. As described in further detail below, the AI model may use various inputs, such as a type of vehicle required to perform the trip or deliver (e.g., a passenger car versus a cargo truck), availability of A Vs in the area, whether a candidate AV is owned by the requestor, preferences and/or restrictions of the owners of candidate AVs, costs associated with candidate AVs, a risk or safety associated with candidate AVs, states or conditions of candidate AVs, capabilities of AVs (e.g., refrigeration or freezing), performance characteristics of AVs (e.g., speed or energy efficiency), and/or other such factors. In some embodiments, owners of candidate AVs (e.g., cars, light trucks, semis, drones, etc.) may automatically accept or decline passengers, loads, and/or materials. Additionally, insurance costs may be automatically determined and/or insurance may be automatically underwritten and/or applied to a trip or delivery based upon known profiles and factors.

In some embodiments, the AI model may output a type of AV (sometimes referred to herein as an “AV type”) of a plurality of types of AV. They type of vehicle may by determined based upon who or what is to be delivered per the transportation request. For example, an autonomous truck or van may be selected for delivery of goods, and a passenger car or bus may be selected for a delivery involving persons. The size or capacity of the AV, or number of AVs to be used, may be selected in accordance with the transportation request. For example, a bus may be selected for a trip involving large group of people, while a car may be selected for a trip involving one or two people. Similarly, a semi-truck may be selected to transport a truckload of goods, while a drone, car, or van may be selected to transport a smaller load (e.g., a single package). In some embodiments, the AI model may select, for example, a smallest, safest, and/or most energy-efficient AV that is capable of the requested transport, in order to reduce overall costs (e.g., energy and insurance costs) and to free up other AVs that may be required for larger transportation tasks. Accordingly, various factors, such as the capacity and type of the AV, costs (e.g., energy and insurance costs) associated with using the AV for a trip or delivery, safety, and availability of different AVs in the area, may be weighed by the AI model to select an AV for the trip or delivery.

In some embodiments, historical preferences or other historical data associated with the user requesting transportation or another person involved in the transportation (e.g., a person to be transported, a person on whose behalf goods are being transported, an owner of an AV or AV fleet) may be factored by the AI model in selecting an AV for a trip or delivery. For example, if a user submitting a given transportation request has shown a historical preference for prioritizing safety, the AI model may select an AV associated a highest safety or lowest insurance cost, possibly at the expense of other factors. For example, if an autonomous van and an autonomous drone are available for a delivery, and the van is determined to be safer or less expensive to insure, the van may be selected even if the drone would be faster or more energy efficient. Historical preferences of users also may relate to preferred routes, types of vehicles, states or conditions of vehicles (e.g., cleanliness, whether the vehicle is new or has some wear-and-tear), performance characteristics of vehicles (e.g., speed or energy efficiency), or other such factors. Other historical data may include historical costs and/or event data associated with events (e.g., accidents, injuries, and/or damages) associated with historical trips or deliveries.

In some embodiments, a transportation request may be automatically declined (e.g., in general or with respect to a specific AV) based upon historical factors. For example, if a certain good is determined to be too hazardous to be transported by certain AVs, the certain AVs may not be selected, or if the good is considered too hazardous to be transported by any available AV, the transportation request may be declined. Similarly, if a certain passenger has historically shown a pattern of damaging AVs in which the certain passenger is being transported, a transportation request including the certain passenger may be automatically declined. Persons or entities that own or control AVs or fleets of AVs may register operator parameters (e.g., a maximum predicted risk and/or insurance costs, forbidden classes of goods or passengers) with the server computing device, which may be used by the server computing device and/or AI model to determine when to automatically decline to make their AV or AVs available for a particular transportation request.

### Generating a Route for a Trip or Delivery Using an Artificial Intelligence Model

In the exemplary embodiment, the server computing device may be further configured to generate routes to be traveled by the selected AV based upon input data using the AI model trained using historical transportation data. In some embodiments, the server computing device may update and/or make changes to the route in real time (e.g., after the trip has started) based upon new data (e.g., data indicating traffic conditions have changed and/or service outages have occurred at a given location).

In some embodiments, the route may be generated by the AI model based upon the input data and further based upon intermediate factors that may be determined based upon the input data (e.g., using the AI model). These intermediate factors may include, for example, user preferences as determined by trends over time, predicted trip durations associated with different potential routes, predicted trip lengths associated with different potential routes, predicted trip costs (e.g., rental costs, fares, and/or insurance costs) associated with different potential routes, safety and/or risk associated with different potential routes, insurance costs associated with potential routes, predicted carbon emissions associated with different potential routes, and/or other factors that may vary depending on the specific route selected. The server computing device may select the generated route based in part upon optimizing one or more of these intermediate factors. In some embodiments, the server computing device may generate multiple routes that prioritize different ones of these factors (e.g., a shortest distance and a shortest predicted duration), and the user may select from among the generated routes.

In some embodiments, to generate the route, the server computing device may consider user preferences as determined by trends over time. For example, if a user has historically preferred to prioritize a certain factor (e.g., speed, improving safety, reducing carbon emissions), the server computing device may select a route based upon these factors In some embodiments, the server computing device may infer or predict preferences of the user based upon user profile data. For example, in some instances, the server computing device may determine that an older passenger is more likely to prioritize safety over speed. Further preferences that may be considered include historical patterns indicating the user desires to decrease costs, decrease travel time, decrease travel distance, reduce a number of transfers, stops, or changes, reduce risk or increase safety, reduce insurance costs, reduce carbon emissions, and/or achieve other objectives with respect to travel. For example, if a user has historically opted to utilize routes that are considered safer even which such an option would result in a higher cost, the server computing device may give more weight to safety or risk when selecting a route (e.g., by locations through which to travel that are considered to be safer).

In some embodiments, the server computing device may compute a predicted cost associated with the trip and/or delivery, which may include costs associated with purchasing transportation services (e.g., renting or utilizing an AV) and/or costs associated with insurance. For example, the server computing device may compute (e.g., using the AI model) a risk score associated with different possible routes. The risk or loss score may be determined based upon, for example, AV type, the goods or persons to be transported, geographic location, user history, service provider being used, AV-specific risk scores for the AV being used, choice of route within neighborhoods (e.g., whether the user is comfortable with riskier locations and/or unfamiliar with the risk of a location), passenger-specific risk score (e.g., based upon previous interactions and/or cumulative/ratings provided by driver of rideshare and/or claims behavior), and/or insurer-determined knowledge relating to risks of certain locations along the potential route. The risk score may correspond to a likelihood of injury or financial loss occurring for a selected route, and may be used (e.g., by the server computing device) to compute an insurance premium for a route. This insurance premium may be factored in when determining a cost associated with a route. For example, consider two potential routes: Route A and Route B. Route A has a lower transportation cost (e.g., fuel and/or rental costs) than Route B, but has a higher risk score and therefore a higher associated insurance cost than Route B. Accordingly, if the sum of the transportation cost and insurance cost of Route A is greater than the sum of the transportation cost and insurance cost of Route B, Route B may be selected despite Route B having a higher transportation service cost. Accordingly, factoring insurance costs when selecting a route may result in safer travel patterns over time while reducing overall costs of travel.

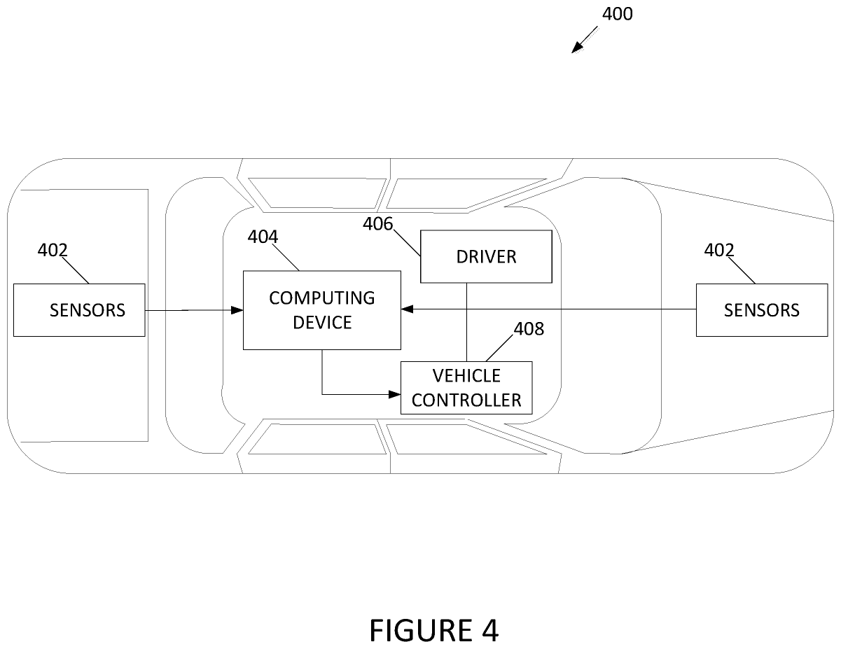

In the exemplary embodiment, the server computing device may transmit route data to the selected autonomous vehicle cause the selected AV to travel the generate route. The route data may include, for example, waypoints, information about timing, information about preferred driving behavior (e.g., whether to travel at or under an allowed speed limit), or other information that may be used by the AV to successfully travel the route generated by the AI model. In some embodiments, autonomous driving functions of the AV may be performed locally by a computing device of the AV (as described in further detail below with respect to FIG. 4). Alternatively, the server computing device or another remote computing device may perform at least some of the autonomous driving functions.

In some embodiments the server computing device may be configured to collect information (e.g., telematics data) from sensors of the AV. The server computing device may use this collected data to further understand user behavior and to further build and refine the AI model. In some embodiments, the server computing device may be further configured to generate a real-time risk score based in part upon telematics data collected during the trip. The risk score may be used to determine and/or adjust an insurance cost associated with the trip, and may be used to modify the route. For example, if the server determines based upon telematics data that a route has become unsafe or less-safe than a stored threshold (e.g., traffic, road, weather, and/or travel conditions have become less safe), the server computing device may generate an updated route and transmit updated route data to the AV.

In embodiments in which the AI model is configured to generate routes for non-autonomous vehicles, the server computing device may further generate a user interface including directions for travelling the route, which the server computing device may cause to be displayed, for example, on a user device.

### Facilitating Payment Using an Artificial Intelligence Model

In the exemplary embodiment, the server computing device facilitate payment for transportation services using the AI model. For example, the AI model may be configured to output costs (e.g., costs for transportation services and/or insurance) associated with a transportation request. Such costs may be updated upon completion of the trip or delivery. For example, if sensors detect a change in condition (e.g., mess and/or damage) of the AV during the trip, the cost may be adjusted to account for the change in condition (e.g., to pay for cleaning/or repair). The determined costs may automatically be transferred from the requester of the transportation to the entity owning or controlling the AV used for transportation.

For example, in some embodiments, the server computing device may generate a bill (e.g., for a trip or delivery or for trips or deliveries during a predefined period), which the user may be prompted to pay via the application. In some embodiments, the payment may automatically be deducted from a pre-paid account or other financial account linked to the user's profile. In some embodiments, in response to a transportation request being accepted, the server computing device may generate a smart contract (e.g., using the AI model) including parameters for the trip or delivery, which may be automatically settled by the server computing device upon completion of the trip or delivery. For example, the payment may automatically be triggered when the server computing device detects that the passenger and/or goods have reached their intended destination. In some embodiments, the generated smart contracts may be stored in a blockchain format and/or another format that automatically prevents the smart contract from being untraceably altered once stored.

In some embodiments, payments may be subscription based, with the user being periodically billed a subscription amount. For example, the server computing device (e.g., using the AI model) may determine that a recurring pattern of transportation use having a predictable cost is occurring. For example, a supplier may periodically send a shipment to a particular buyer, or a passenger may use a rideshare service to commute to and home from work each day. In such embodiments, the server computing device may determine an aggregated predicted transportation cost for a period. The user may pay this cost as a periodic subscription amount (e.g., each month), rather than paying for individual trips or deliveries. This cost may be adjusted periodically based upon feedback (e.g., changes in use, changes in risk behavior, changes in transportation and/or insurance costs, and/or the occurrence of injuries and/or accidents), which in turn may be determined based upon, for example, telematics data and/or claims or incident reports associated with completed trips or deliveries.

At least one of the technical problems addressed by this system may include: (i) inability of a computing device to select an AV for completing a transportation request using an AI model trained based upon historical transportation data; (ii) inability of a computing device to generate a route for an AV using an AI model trained based upon historical trip data; (iii) inability of a computing device to select an AV and/or generate a route based upon user preferences using an AI model trained based upon historical transportation data including data specifying types of transportation used for the historical trips of the user; (iv) inability of a computing device to determine a safety or risk level of a route using an AI model trained based upon historical trip data (e.g., historical destinations, routes, types of AV used, telematics data, costs, user feedback, and/or events such as collisions, damages, and/or injuries occurring during the trip); and/or (v) inability of an AI model to enable AV operators to set parameters under which a AI model can or cannot select an AV for use in completing a transportation request.

A technical effect of the systems and processes described herein may be achieved by performing at least one of the following steps: (i) receiving, from a user device, a transportation request including an origin, a destination, and at least one good or person to be transported; (ii) selecting, based upon the transportation request using an AI model, an AV of a plurality of candidate AVs in communication with the server computing device, wherein the AI model is trained using historical transportation records including historical transportation data associated with historical transportation; (iii) generating, based upon the transportation request using the AI model, a route for the AV; and/or (iv) transmitting route data to the selected AV, wherein the route data causes the selected AV to travel the generated route.

The technical effect achieved by this system may be at least one of: (i) ability for a computing device to select an AV for completing a transportation request using an AI model trained based upon historical transportation data; (ii) ability for a computing device to generate a route for an AV using an AI model trained based upon historical trip data; (iii) inability of a computing device to select an AV and/or generate a route based upon user preferences using an AI model trained based upon historical transportation data including data specifying types of transportation used for the historical trips of the user; (iv) ability for a computing device to determine a safety or risk level of a route using an AI model trained based upon historical trip data (e.g., historical destinations, routes, types of AV used, telematics data, costs, user feedback, and/or events such as collisions, damages, and/or injuries occurring during the trip); and/or (v) ability for an AI model to enable AV operators to set parameters under which a AI model can or cannot select an AV for use in completing a transportation request.

### Exemplary Computer System

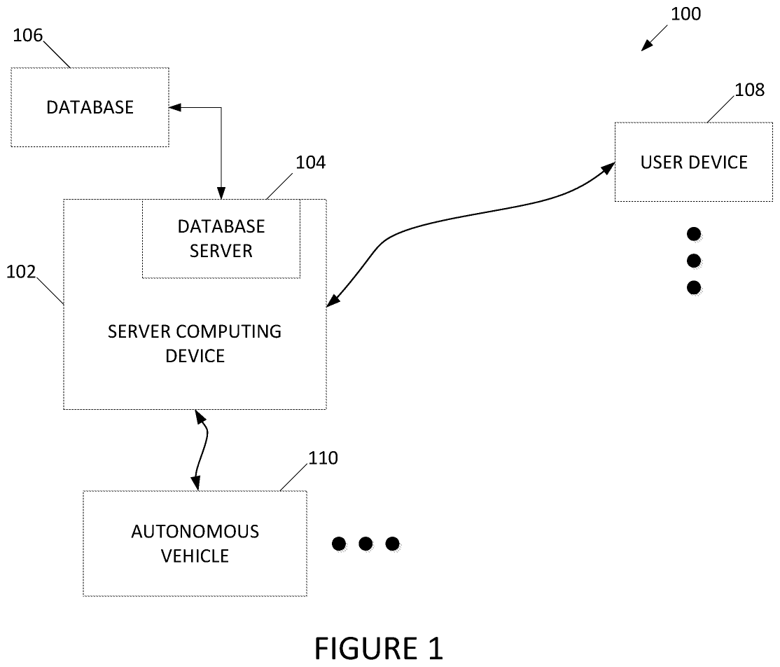

FIG. 1 depicts an exemplary computer system 100 for the present disclosure. Computer system 100 may include a server computing device 102 (which may include one or more computing devices and/or one or more processors) including a database server 104. Server computing device 102 may be in communication with a database 106 and/or one or more user devices 108 associated with one or more users, and one or more AVs 110.

In the exemplary embodiment, server computing device 102 may be configured to retrieve input data that may be used to select an AV 110 and/or generate a route for a received transportation request. Certain input data (e.g., an origin and/or desired destination, who is being transported or what type of good is being transported, pricing data, traffic data, weather data, and/or road condition data) may be specific to a given trip, while other input data (e.g., user preferences, geographic data, historical trend data) may apply generally to multiple trips and/or deliveries. In some embodiments, each user may have a user profile (e.g., associated with a user login account), which may include information associated with the respective user.

In the exemplary embodiment, server computing device 102 may receive an origin, a destination, and data describing who is being transported or what type and how much of a good is being transported for a requested trip and/or delivery. For example, server computing device 102 may cause an application executing on user device 108 to prompt a user to input an origin, destination, and who and/or what is to be transported. In some embodiments, the user may further input (e.g., via the mobile application) certain waypoints, or intermediate points between the origin and destination through which the route must pass. In some embodiments, the user may specify a time for the trip and/or delivery (e.g., via the application). For example, the user may request the trip and/or delivery immediately, or may specify a future time for the trip and/or delivery. The future time may be a single instance or may be recurring (e.g., daily or weekly). In some embodiments, the user may be prompted by the application to log into the user's login account prior to receiving a transportation request from the user. In some embodiments, the application may include a chatbot functionality, through which the user may request a route and/or other information using text and/or natural language. Such text and/or natural language inputs may be analyzed using AI and/or chatbot programs (e.g., ChatGPT), which in some embodiments may generate text and/or natural language responses to be presented through the application. In some embodiments, the transportation request may be generated based upon preexisting records, such as by being generated based upon data retrieved from a smart contract stored, for example, in a blockchain format, or another record including data relevant for generating the transportation request (e.g., emails, text messages, invoices, etc.).

In some embodiments, server computing device 102 may further retrieve geographic data based upon which AV 110 may be selected and/or the route may be generated. The geographic data may include data describing topography, locations or thoroughfares such as highways, roads, bike paths, trails, and sidewalks, mass transit routes, safety statistics (e.g., rates of traffic collisions and/or crime), and zones in which certain transportation services may be available. The geographic data may be retrieved from a database such as database 106, the Internet (e.g., from third-party mapping services, such as Google Maps), and/or other sources capable of providing such data, and may be periodically or continually updated to reflect a current state.

In some embodiments, server computing device 102 may further retrieve contextual data, or data describing current or real-time conditions, based upon which AV 110 may be selected and/or the route may be generated. The contextual data may include data describing traffic conditions, road conditions (e.g., construction), major events that may affect traffic flow (e.g., locations of conventions, concerts and/or sporting events), weather, time of day, time of year, or other conditions that may affect travel. The geographic data may be retrieved from a database such as database 106, the Internet (e.g., from third-party mapping services, such as Google Maps), and/or other sources capable of providing such data, and may be periodically or continually updated (e.g., in real time) to reflect current conditions. As described in further detail below, server computing device 102 may be configured to update generated routes in real time (e.g., after travel has started) if contextual data indicates that conditions have changed from when the route was initially generated.

In some embodiments, server computing device 102 may further retrieve user profile data. The user profile data may include preferences to use certain types of transportation, age, health information, demographic information, historical trips and/or deliveries and patterns of trips and/or deliveries, historical usage of different AVs 110 and/or types of AVs 110, frequently visited locations, locations frequently delivered to and/or from, historical accident information, historical events and/or claims (sometimes referred to herein as “event data”), and/or preferred billing option. The user profile data may be retrieved from a database such as database 106, the Internet, and/or other sources capable of providing such data. For example, user profiles including user profile data may be stored for each user in database 106. The user profile information may be entered by the user (e.g., via a preference and/or settings interface of the mobile app), automatically compiled based upon historical trips and/or deliveries, and/or automatically retrieved from other data sources (e.g., insurance, financial, and/or transportation service accounts linked to the user profile and/or associated with the user). In some embodiments, the application may initially autofill the user profile with automatically compiled user profile information and allow the user to manually make changes to the information.

The user profile data may further include historical telematics data (e.g., acceleration, cornering, braking, position, velocity, orientation, speed, location, GPS location or other GPS information, etc.) associated with previous trips taken by the user. The telematics data may be collected by sensors of AV 110, user devices 108, and/or telematics devices communicatively linked to AV 110 during trips (e.g., via Bluetooth and/or another wired or wireless communication protocol), and/or transportation service accounts (e.g., rideshare accounts and/or accounts associated with delivery and/or shipping services) linked to the user profile that may collect and/or store telematics data during trips. The user profile may further include user feedback from previous trips. For example, the application may prompt the user to rate a trip or delivery upon completion of the trip or delivery, and over time, server computing device 102 may identify aspects of a trip or delivery that are preferred by the user based upon the submitted ratings.

In the exemplary embodiment, server computing device 102 may be configured to generate an AI model, that may be used to select AVs 110, generate routes, and/or determine other metrics associated with selected AVs 110 and routes (e.g., costs and/or amount of risk) based upon input data. In some embodiments, server computing device 102 may generate and/or train the AI model using a training dataset that includes one or more training variables and/or model parameters, such as historical transportation data (e.g., data associated with previous trips and/or deliveries performed by AVs 110), historical geographic data, historical contextual data, historical user profile data (e.g., including historical preferences of users), and/or historical event data (e.g., data relating to incidents and/or claims associated with previously completed trips or deliveries).

In other embodiments, server computing device 102 may generate the AI model in a different format. For example, the AI model may be a function for receiving data (e.g., a desired destination, on origin, passenger and/or goods to be transported, geographic data, contextual data, and user profile data) and generating an output for selecting an AV 110 and determining a route from the specified origin to the specified destination.

The server computing device 102 may be configured to generate the AI by analyzing historical trip and/or delivery records including historical trip and/or delivery data (e.g., historical origins, destinations, passengers and/or goods transported, routes, AVs 110 and/or types of AVs 110 used, telematics data, costs, user feedback, and/or events such as collisions, damages, and/or injuries occurring during the trip) associated with historical trips and/or deliveries. server computing device 102 may be configured to perform a statistical analysis of the historical trip and/or delivery records to generate the AI model. For example, for an aspect of a historical trip and/or delivery (e.g., origins, destinations, passengers and/or goods transported, routes, types of transportation used, telematics data, costs, user feedback, and/or events such as collisions and/or injuries that occurred during the trip), server computing device 102 may identify historical trip and/or delivery records associated with the aspect and generate model parameters (e.g., by identifying other parameters held in common among the identified historical trip and/or delivery records). For example, server computing device 102 may identify features correlated with a particular historical pattern of a user traveling between a certain origin and destination or similar goods being delivered between a certain origin and destination, and which routes and types of AV 110 were used for these historical trips. In other embodiments, server computing device 102 may be configured to perform a different analysis that is suitable to generate the AI model.

The AI model may be associated with and/or include a parametric engine. The parametric engine represents a relationship between input data such as training variables and/or predicted outputs. The training variables may be parameterized allowing the parametric engine to be tuned to generate accurate outputs. Parameterized training variables may be weighted using weighting coefficients. The parametric engine may be tuned to determine a magnitude and/or a direction of the weighting coefficients. Tuning may include iteratively using the parametric engine to generate model outputs that correspond to an actual event, such as a historical trip and/or delivery, while adjusting the magnitude and direction of the weight coefficients until the error between the model output and the actual event is reduced to an acceptable level. Tuning may be performed in addition to, and/or in combination with, training the model using historical data.

The parametric engine may use the weighted coefficients to rank an importance or influence of a model training variable. For example, the greater the weighting factor the greater the importance server computing device 102 will associate with that variable when tuning the model. Likewise, the smaller the weighting factor the lesser the importance that server computing device 102 will associate with the variable when tuning the model. In some embodiments, server computing device 102 may weight variables associated with the historical trip and/or delivery records greater than any other model training variables.

In some embodiments, server computing device 102 may use a reduced number of training variables (e.g., one or more training variables) that have the greatest weighting factors (e.g., the variables that are ranked with the most importance). The reduced and more focused training dataset, including the training variables with the greatest weights, decreases computational load and will have decreased model training time allowing the model to be more quickly updated as more historical trip and/or delivery records are created and added to the subset training dataset. server computing device 102 may generate a training dataset including less than a particular number (e.g., five or three) model training variables, for example.

In the exemplary embodiment, server computing device 102 may be further configured to select one or more AVs 110 from a group of candidate AVs 110 for a requested trip or delivery using the generated AI model. The AI model may be configured to output a specific AV 110 for performing the trip or delivery. As described in further detail below, the AI model may use various inputs, such as a type of vehicle required to perform the trip or deliver (e.g., a passenger car versus a cargo truck), availability of AVs 110 in the area, whether a candidate AV 110 is owned by the requestor, preferences and/or restrictions of the owners of candidate AVs 110, costs associated with candidate AVs 110, a risk or safety associated with candidate AVs 110, states or conditions of candidate AVs 110, capabilities of AVs (e.g., refrigeration or freezing) 110, performance characteristics of AVs 110 (e.g., speed or energy efficiency), and/or other such factors. In some embodiments, owners of candidate AVs 110 (e.g., cars, light trucks, semis, drones, etc.) may automatically accept or decline passengers, loads, and/or materials. Additionally, insurance costs may be automatically determined and/or insurance may be automatically underwritten and/or applied to a trip or delivery based upon known profiles and factors.

In some embodiments, the AI model may output a type of AV 110 of a plurality of types of AV 110. They type of vehicle may by determined based upon who or what is to be delivered per the transportation request. For example, an autonomous truck or van may be selected for delivery of goods, and a passenger car or bus may be selected for a delivery involving persons. The size or capacity of AV 110, or number of AVs 110 to be used, may be selected in accordance with the transportation request. For example, a bus may be selected for a trip involving large group of people, while a car may be selected for a trip involving one or two people. Similarly, a semi-truck may be selected to transport a truckload of goods, while a drone, car, or van may be selected to transport a smaller load (e.g., a single package). In some embodiments, the AI model may select, for example, a smallest, safest, and/or most energy-efficient AV 110 that is capable of the requested transport, in order to reduce overall costs (e.g., energy and insurance costs) and to free up other AVs 110 that may be required for larger transportation tasks. Accordingly, various factors, such as the capacity and type of AV 110, costs (e.g., energy and insurance costs) associated with using the AV 110 for a trip or delivery, safety, and availability of different AVs 110 in the area, may be weighed by the AI model to select an AV 110 for the trip or delivery.

In some embodiments, historical preferences or other historical data associated with the user requesting transportation or another person involved in the transportation (e.g., a person to be transported, a person on whose behalf goods are being transported, an owner of an AV 110 or fleet of AVs 110) may be factored by the AI model in selecting an AV 110 for a trip or delivery. For example, if a user submitting a given transportation request has shown a historical preference for prioritizing safety, the AI model may select an AV 110 associated a highest safety or lowest insurance cost, possibly at the expense of other factors. For example, if an autonomous van and an autonomous drone are available for a delivery, and the van is determined to be safer or less expensive to insure, the van may be selected even if the drone would be faster or more energy efficient. Historical preferences of users also may relate to preferred routes, types of vehicles, states or conditions of vehicles (e.g., cleanliness, whether the vehicle is new or has some wear-and-tear), performance characteristics of vehicles (e.g., speed or energy efficiency), or other such factors. Other historical data may include historical costs and/or event data associated with events (e.g., accidents, injuries, and/or damages) associated with historical trips or deliveries.

In some embodiments, a transportation request may be automatically declined (e.g., in general or with respect to a specific AV 110) based upon historical factors. For example, if a certain good is determined to be too hazardous to be transported by certain AVs 110, the certain AVs 110 may not be selected, or if the good is considered too hazardous to be transported by any available AV 110, the transportation request may be declined. Similarly, if a certain passenger has historically shown a pattern of damaging AVs 110 in which the certain passenger is being transported, a transportation request including the certain passenger may be automatically declined. Persons or entities that own or control AVs 110 or fleets of AVs 110 may register operator parameters (e.g., a maximum predicted risk and/or insurance costs, forbidden classes of goods or passengers) with server computing device 102, which may be used by server computing device 102 and/or AI model to determine when to automatically decline to make their AV 110 or AVs 110 available for a particular transportation request.

In the exemplary embodiment, server computing device 102 may be further configured to generate routes to be traveled by the selected AV 110 based upon input data using the AI model trained using historical transportation data. In some embodiments, server computing device 102 may update and/or make changes to the route in real time (e.g., after the trip has started) based upon new data (e.g., data indicating traffic conditions have changed and/or service outages have occurred at a given location).

In some embodiments, the route may be generated by the AI model based upon the input data and further based upon intermediate factors that may be determined based upon the input data (e.g., using the AI model). These intermediate factors may include, for example, user preferences as determined by trends over time, predicted trip durations associated with different potential routes, predicted trip lengths associated with different potential routes, predicted trip costs (e.g., rental costs, fares, and/or insurance costs) associated with different potential routes, safety and/or risk associated with different potential routes, insurance costs associated with potential routes, predicted carbon emissions associated with different potential routes, and/or other factors that may vary depending on the specific route selected. server computing device 102 may select the generated route based in part upon optimizing one or more of these intermediate factors. In some embodiments, server computing device 102 may generate multiple routes that prioritize different ones of these factors (e.g., a shortest distance and a shortest predicted duration), and the user may select from among the generated routes.

In some embodiments, to generate the route, server computing device 102 may consider user preferences as determined by trends over time. For example, if a user has historically preferred to prioritize a certain factor (e.g., speed, improving safety, reducing carbon emissions), server computing device 102 may select a route based upon these factors In some embodiments, server computing device 102 may infer or predict preferences of the user based upon user profile data. For example, in some instances, server computing device 102 may determine that an older passenger is more likely to prioritize safety over speed. Further preferences that may be considered include historical patterns indicating the user desires to decrease costs, decrease travel time, decrease travel distance, reduce a number of transfers, stops, or changes in transportation service type, reduce risk or increase safety, reduce insurance costs, reduce carbon emissions, and/or achieve other objectives with respect to travel. For example, if a user has historically opted to utilize routes that are considered safer even which such an option would result in a higher cost, server computing device 102 may give more weight to safety or risk when selecting a route (e.g., by locations through which to travel that are considered to be safer).

In some embodiments, server computing device 102 may compute a predicted cost associated with the trip and/or delivery, which may include costs associated with purchasing transportation services (e.g., renting or utilizing an AV 110) and/or costs associated with insurance. For example, server computing device 102 may compute (e.g., using the AI model) a risk score associated with different possible routes. The risk or loss score may be determined based upon, for example, AV type, the goods or persons to be transported, geographic location, user history, service provider being used, AV-specific risk scores for the AV 110 being used, choice of route within neighborhoods (e.g., whether the user is comfortable with riskier locations and/or unfamiliar with the risk of a location), passenger-specific risk score (e.g., based upon previous interactions and/or cumulative/ratings provided by driver of rideshare and/or claims behavior), and/or insurer-determined knowledge relating to risks of certain locations along the potential route. The risk score may correspond to a likelihood of injury or financial loss occurring for a selected route, and may be used (e.g., by server computing device 102) to compute an insurance premium for a route. This insurance premium may be factored in when determining a cost associated with a route. For example, consider two potential routes: Route A and Route B. Route A has a lower transportation cost (e.g., fuel and/or rental costs) than Route B, but has a higher risk score and therefore a higher associated insurance cost than Route B. Accordingly, if the sum of the transportation cost and insurance cost of Route A is greater than the sum of the transportation cost and insurance cost of Route B, Route B may be selected despite Route B having a higher transportation service cost. Accordingly, factoring insurance costs when selecting a route may result in safer travel patterns over time while reducing overall costs of travel.

In the exemplary embodiment, server computing device 102 may transmit route data to the selected autonomous vehicle cause the selected AV 110 to travel the generate route. The route data may include, for example, waypoints, information about timing, information about preferred driving behavior (e.g., whether to travel at or under an allowed speed limit), or other information that may be used by AV 110 to successfully travel the route generated by the AI model. In some embodiments, autonomous driving functions of AV 110 may be performed locally by a computing device of AV 110 (as described in further detail below with respect to FIG. 4). Alternatively, server computing device 102 or another remote computing device may perform at least some of the autonomous driving functions.

In some embodiments server computing device 102 may be configured to collect information (e.g., telematics data) from sensors of AV 110. Server computing device 102 may use this collected data to further understand user behavior and to further build and refine the AI model. In some embodiments, server computing device 102 may be further configured to generate a real-time risk score based in part upon telematics data collected during the trip. The risk score may be used to determine and/or adjust an insurance cost associated with the trip, and may be used to modify the route. For example, if the server determines based upon telematics data that a route has become unsafe or less-safe than a stored threshold (e.g., traffic, road, weather, and/or travel conditions have become less safe), server computing device 102 may generate an updated route and transmit updated route data to AV 110.

In embodiments in which the AI model is configured to generate routes for non-autonomous vehicles, server computing device 102 may further generate a user interface including directions for travelling the route, which the server computing device may cause to be displayed, for example, on a user device 108.

In the exemplary embodiment, server computing device 102 facilitate payment for transportation services using the AI model. For example, the AI model may be configured to output costs (e.g., costs for transportation services and/or insurance) associated with a transportation request. Such costs may be updated upon completion of the trip or delivery. For example, if sensors detect a change in condition (e.g., mess and/or damage) of AV 110 during the trip, the cost may be adjusted to account for the change in condition (e.g., to pay for cleaning/or repair). The determined costs may automatically be transferred from the requester of the transportation to the entity owning or controlling AV 110 used for transportation.

For example, in some embodiments, server computing device 102 may generate a bill (e.g., for a trip or delivery or for trips or deliveries during a predefined period), which the user may be prompted to pay via the application. In some embodiments, the payment may automatically be deducted from a pre-paid account or other financial account linked to the user's profile. In some embodiments, in response to a transportation request being accepted, server computing device 102 may generate a smart contract (e.g., using the AI model) including parameters for the trip or delivery, which may be automatically settled by server computing device 102 upon completion of the trip or delivery. For example, the payment may automatically be triggered when server computing device 102 detects that the passenger and/or goods have reached their intended destination. In some embodiments, the generated smart contracts may be stored in a blockchain format and/or another format that automatically prevents the smart contract from being untraceably altered once stored.

In some embodiments, payments may be subscription based, with the user being periodically billed a subscription amount. For example, server computing device 102 (e.g., using the AI model) may determine that a recurring pattern of transportation use having a predictable cost is occurring. For example, a supplier may periodically send a shipment to a particular buyer, or a passenger may use a rideshare service to commute to and home from work each day. In such embodiments, server computing device 102 may determine an aggregated predicted transportation cost for a period. The user may pay this cost as a periodic subscription amount (e.g., each month), rather than paying for individual trips or deliveries. This cost may be adjusted periodically based upon feedback (e.g., changes in use, changes in risk behavior, changes in transportation and/or insurance costs, and/or the occurrence of injuries and/or accidents), which in turn may be determined based upon, for example, telematics data and/or claims or incident reports associated with completed trips or deliveries.

### Exemplary Client Computing Device

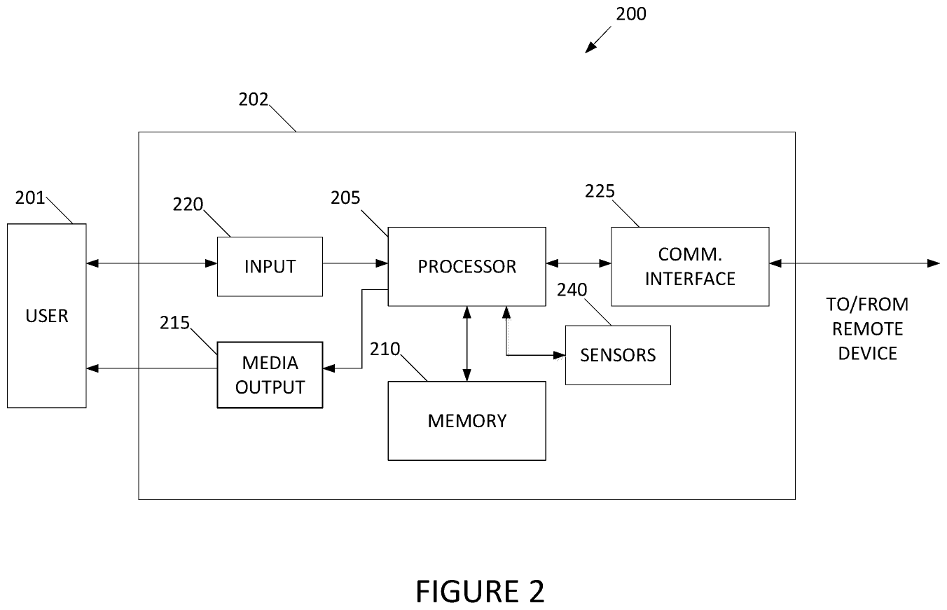

FIG. 2 depicts an exemplary client computing device 202. Client computing device 202 may be, for example, at least one of user device 108 and/or AV 110 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In certain exemplary embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as server computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

In some embodiments, client computing device 202 may also include sensors 240. Sensors 240 may include, for example, an accelerometer, a global positioning system (GPS), or a gyroscope. Sensors 240 may be used to collect telematics data, which may be transmitted by client computing device 202 a remote device such as server computing device 102 (shown in FIG. 1).

Stored in memory area 210 may be, for example, computer readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website. A client application may allow user 201 to interact with a server application from server computing device 102 (shown in FIG. 1).

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Server System

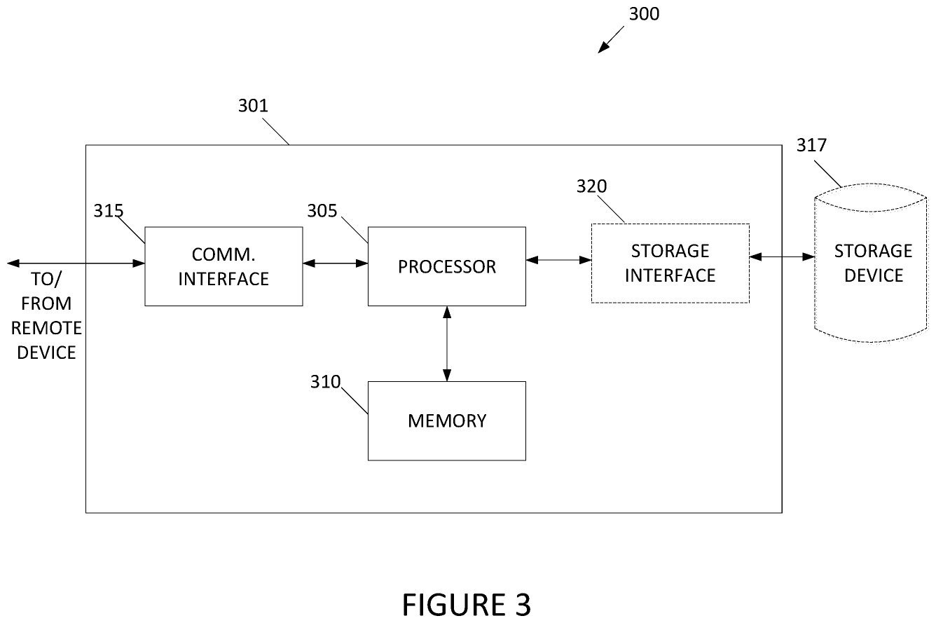

FIG. 3 depicts an exemplary server system that may be used with computer system 100 illustrated in FIG. 1. Server system 301 may be, for example, server computing device 102 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with user device 108 and/or AV 110 (all shown in FIG. 1), or another server system 301. For example, communication interface 315 may receive requests from user device 108 via the Internet. Further, processor 305, via communication interface 315, may be capable of causing funds to be transferred between various entities, such as, for example, accounts associated with user device 108 and/or entities associated with (e.g., owners, operators, and/or insurers of) AV 110 (all shown in FIG. 1).

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317.

In other embodiments, storage device 317 may be external to server system 301 and may be accessed by a plurality of server systems 301. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317. In some embodiments, processor 305 may include and/or be communicatively coupled to one or more modules for implementing the systems and methods described herein.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Transportation Device

FIG. 4 depicts an exemplary transportation device 400. Transportation device 400 may be, for example, AV 110 and/or another transportation device including a processing component capable of communicating with external computing devices (e.g., server computing device 102 shown in FIG. 1). In some embodiments, transportation device 400 may be a conventional and/or autonomous automobile, a motorcycle, a bicycle, a powered scooter (e.g., an electric scooter), a bus, a train, a truck, a van, an aircraft, a drone, and/or another type of vehicle.

Transportation device 400 may include a plurality of sensors 402 and a computing device 404. Sensors 402 may include, but are not limited to, temperature sensors, terrain sensors, weather sensors, accelerometers, gyroscopes, radar, LIDAR, Global Positioning System (GPS), video devices, imaging devices, cameras (e.g., 2D and 3D cameras), audio recorders, and computer vision. In some embodiments, sensors 402 may be used to collect, for example, vehicle telematics data, as described above. In addition, sensors 402 may be used to collect additional information, for example, whether any external devices (e.g., user device 108) are communicatively linked to and/or otherwise in proximity to transportation device 400.

Such telematics data and/or sensor data collected by sensors 402 may be transmitted to server computing device 102 (shown in FIG. 1). The telematics data may be transmitted, for example, via user device 108 (shown in FIG. 1), which may be communicatively linked to transportation device 400 (e.g., via a physical dock and/or a wireless connection).

Computing device 404 may be implemented, for example, as client computing device 202 (shown in FIG. 2). In exemplary embodiments, computing device 404 may receive data from sensors 402. In certain embodiments where server computing device 102 is remote from transportation device 400, computing device 404 may transmit data received from sensors 402 (e.g., vehicle telematics data) to server computing device 102. Alternatively, server computing device 102 may be implemented as computing device 404 and/or computing device 404 may execute some or all of the functions described with respect to server computing device 102.

In exemplary embodiments, vehicle controller 408 may control at least some operation of transportation device 400. For example, vehicle controller 408 may steer, accelerate, or decelerate transportation device 400 based upon data received, for example, from sensors 402. For example, vehicle controller 408 may be configured to cause transportation device to autonomously travel between waypoints and/or along a prescribed route (e.g., waypoints and/or routes generated by server computing device 102 shown in FIG. 1). In some embodiments, vehicle controller 408 may include a display screen or touchscreen (not shown) that is capable of displaying information to and/or receiving input from driver 406.

In other embodiments, vehicle controller 408 may be capable of wirelessly communicating with a user mobile device such as user device 108 that is within or remote from transportation device 400. In these embodiments, vehicle controller 408 may be capable of communicating with the user of user device 108, such as driver 406, through an application on user device 108. In some embodiments, computing device 404 may include vehicle controller 408. In some embodiments, one or more operations associated with computing device 404 and/or vehicle controller 408 may be performed by an external computing device in communication with transportation device 400, such as server computing device 102 (shown in FIG. 1).

### Exemplary Computer-Implemented Method for Autonomous Vehicle Selection & Routing

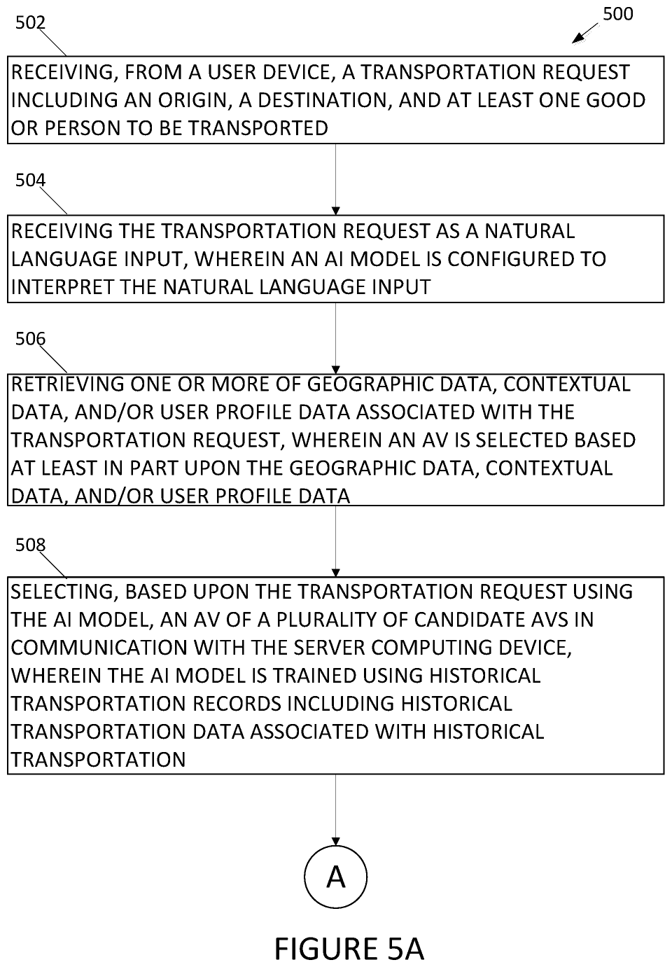

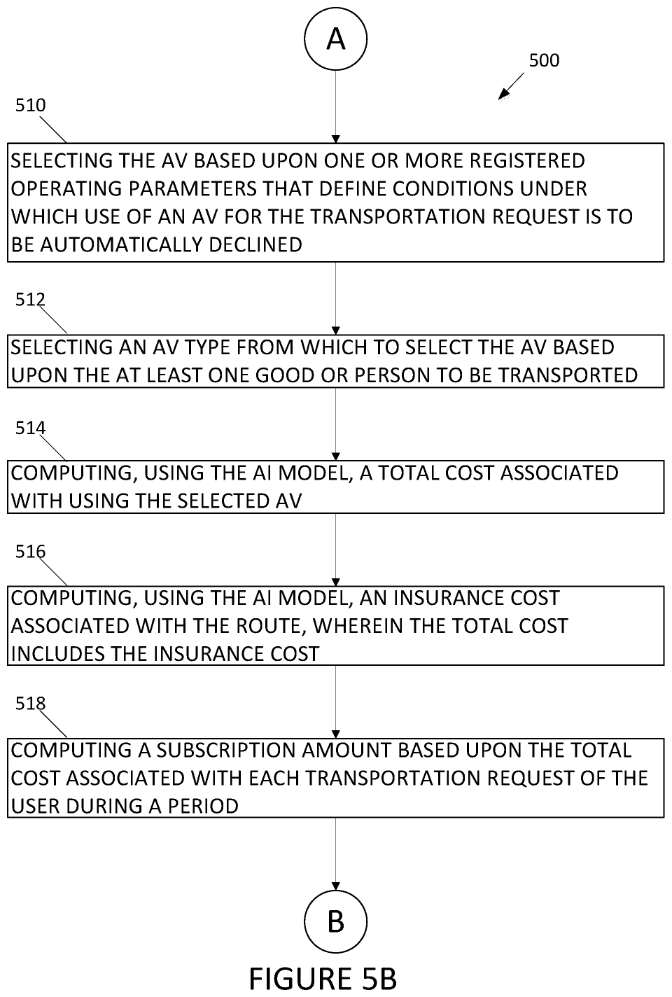

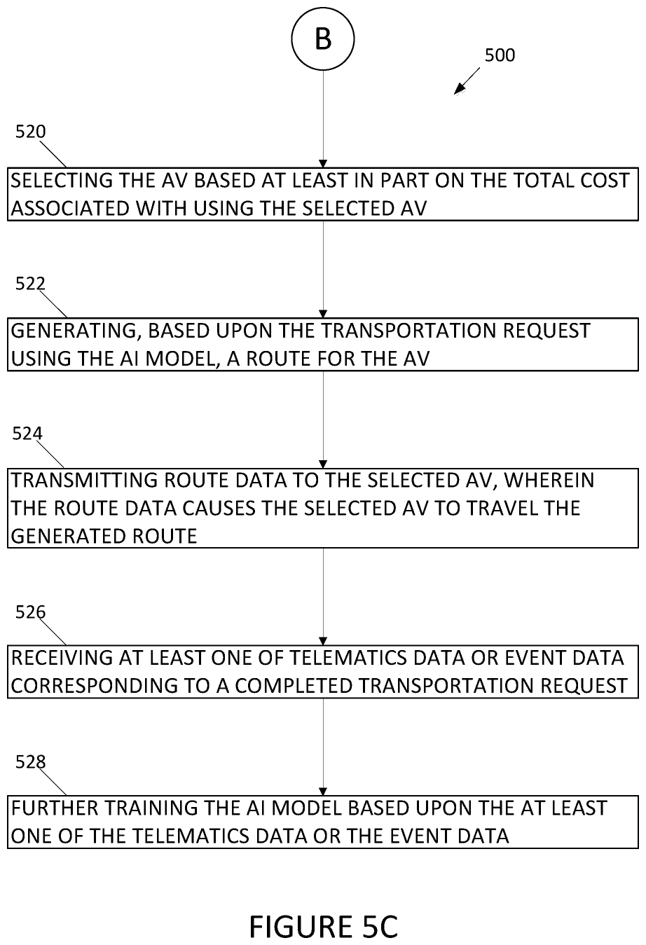

FIGS. 5A, 5B, and 5C are flowcharts that illustrate an exemplary computer-implemented method 500 for autonomous vehicle (AV) selection and routing. Computer-implemented method 500 may be performed by one or more components of computer system 100 (shown in FIG. 1), such as server computing device 102.

In the exemplary embodiment, computer-implemented method 500 may include receiving 502, from a user device (such as user device 108), a transportation request including an origin, a destination, and at least one good or person to be transported. In some embodiments, receiving 502 the transportation request may be performed by server computing device 102 (shown in FIG. 1).

In some embodiments, computer-implemented method 500 may further include receiving 504 the transportation request as a natural language input. The AI model may be configured to interpret the natural language input. In some embodiments, receiving 504 the transportation request as a natural language input may be performed by server computing device 102 (shown in FIG. 1).

In some embodiments, computer-implemented method 500 may further include, in response to receiving the transportation request, retrieving 506 one or more of geographic data, contextual data, and/or user profile data associated with the transportation request. The AV may be selected based at least in part upon the geographic data, contextual data, and/or user profile data. In some embodiments, retrieving 506 one or more of geographic data, contextual data, and/or user profile data may be performed by server computing device 102 (shown in FIG. 1).

In the exemplary embodiment, computer-implemented method 500 may further include selecting 508, based upon the transportation request using an AI model, an AV) of a plurality of candidate AVs in communication with the server computing device. The AI model may be trained using historical trip records including historical transportation data associated with historical transportation. In some embodiments, selecting 508 the AV may be performed by server computing device 102 (shown in FIG. 1).

In some embodiments, computer-implemented method 500 may further include selecting 510 the AV based upon one or more registered operating parameters that define conditions under which use of an AV for the transportation request is to be automatically declined. In some embodiments, selecting 510 the AV based upon one or more registered operating parameters may be performed by server computing device 102 (shown in FIG. 1).

In some embodiments, computer-implemented method 500 may further include selecting 512 an AV type from which to select the AV based upon the at least one good or person to be transported. In some embodiments, selecting 512 the AV type may be performed by server computing device 102 (shown in FIG. 1).

In some embodiments, computer-implemented method 500 may further include computing 514, using the AI model, a total cost associated with using the selected AV. In some embodiments, computing 514 the total cost may be performed by server computing device 102 (shown in FIG. 1).

In some such embodiments, computer-implemented method 500 may further include computing 516, using the AI model, an insurance cost associated with the route. The total cost may include the insurance cost. In some embodiments, computing 516 the insurance cost may be performed by server computing device 102 (shown in FIG. 1).

In some such embodiments, computer-implemented method 500 may further include computing 518 a subscription amount based upon the total cost associated with each transportation request of the user during a period. In some embodiments, computing 518 the subscription amount may be performed by server computing device 102 (shown in FIG. 1).

In some such embodiments, computer-implemented method 500 may further include selecting 520 the AV based at least in part upon the total cost associated with using the selected AV. In some embodiments, selecting 520 the AV based at least in part upon the total cost may be performed by server computing device 102 (shown in FIG. 1).

In the exemplary embodiment, computer-implemented method 500 may further include generating 522, based upon the transportation request using the AI model, a route for the AV. In some embodiments, generating 522 the route may be performed by server computing device 102 (shown in FIG. 1).

In the exemplary embodiment, computer-implemented method 500 may further include transmitting 524 route data to the selected AV, wherein the route data causes the selected AV to travel the generated route. In some embodiments, transmitting 524 the route data may be performed by server computing device 102 (shown in FIG. 1).

In some embodiments, computer-implemented method 500 may further include receiving 526 at least one of telematics data or event data corresponding to a completed transportation request and further training 528 the AI model based upon the at least one of the telematics data or the event data. In some embodiments, receiving 526 the telematics data or event data and training 528 the AI model may be performed by server computing device 102 (shown in FIG. 1).

In some embodiments, computer-implemented method 500 may include additional, less, or alternate functionality, including that discussed elsewhere herein. For example, computer-implemented method 500 may include more or fewer of the steps described with respect to FIG. 5, and/or the steps may be performed in an order other than the order shown in FIG. 5.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, server computing device 102 is configured to implement machine learning, such that server computing device 102 “learns” to analyze, organize, and/or process data without being explicitly programmed. Machine learning may be implemented through machine learning (“ML”) methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to telematics data and user input received from user device 108 and/or AV 110. ML outputs may include but are not limited to insurance premium amounts calculated based upon the received telematics data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing clement may be trained by providing it with a large sample of conversation data with known characteristics or features. Such information may include, for example, information associated with a plurality of different speaking styles and accents.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

Based upon these analyses, the processing element may learn how to identify characteristics and patterns that may then be applied to analyzing telematics data. For example, the processing element may learn, with the user's permission or affirmative consent, to identify an amount of risk associated with the user's actual transportation behavior. This information may be used to calculate an insurance premium based upon the user's transportation activity.

In some embodiments, the voice bots or chatbots discussed herein may be configured to utilize AI and/or ML techniques. For instance, the voice bot or chatbot may be a ChatGPT chatbot. The voice bot or chatbot may employ supervised or unsupervised machine learning techniques, which may be followed by and/or used in conjunction with reinforced or reinforcement learning techniques. The voice bot or chatbot may employ the techniques utilized for ChatGPT. The voice bot or chatbot may deliver various types of output for user consumption in certain embodiments, such as verbal or audible output, a dialogue output, text or textual output (such text or graphics presented on a computer or mobile device screen or display), visual or graphical output, and/or other types of outputs.

For the purposes of this discussion, a chatbot or chatterbot is a software application used to conduct an online chat conversation via text or text-to-speech, in lieu of providing direct contact with a live human agent. Chatbots are computer programs that are capable of maintaining a conversation with a user in natural language, understanding their intent, and replying based upon preset rules and data, and may be designed to convincingly simulate the way a human would behave as a conversational partner.

Chatbots are used in dialog systems for various purposes including customer service, request routing, or information gathering. While some chatbot applications use extensive word-classification processes, natural-language processors, and sophisticated AI, others simply scan for general keywords and generate responses using common phrases obtained from an associated library or database.

Most chatbots are accessed on-line via website popups or through virtual assistants. They can be classified into usage categories that include: commerce (e-commerce via chat), education, entertainment, finance, health, news, and productivity.

For the purposes of this discussion, ChatGPT is an artificial intelligence chatbot. It is built on a family of large language models and has been fine-tuned (an approach to transfer learning) using both supervised and reinforcement learning techniques. ChatGPT is a member of the generative pre-trained transformer (GPT) family of language models. It was fine-tuned (an approach to transfer learning) over previous versions. The fine-tuning process leveraged both supervised learning as well as reinforcement learning in a process called reinforcement learning from human feedback (RLHF). Both approaches used human trainers to improve the model's performance. In the case of supervised learning, the model was provided with conversations in which the trainers played both sides: the user and the AI assistant. In the reinforcement learning step, human trainers first ranked responses that the model had created in a previous conversation. These rankings were used to create ‘reward models’ that the model was further fine-tuned on using several iterations of Proximal Policy Optimization (PPO). Proximal Policy Optimization algorithms present a cost-effective benefit to trust region policy optimization algorithms; they negate many of the computationally expensive operations with faster performance. In addition, chatbots similar to and including ChatGPT continue to gather data from users that could be used to further train and fine-tune the chatbot. Users can upvote or downvote responses they receive from ChatGPT and fill out a text field with additional feedback. The reward model of ChatGPT, designed around human oversight, can be over-optimized and thus hinder performance.

Although the core function of a chatbot is to mimic a human conversationalist, ChatGPT represents a type of chatbot that is versatile. For example, it can write and debug computer programs, compose music, teleplays, fairy tales, and student essays; answer test questions (sometimes, depending on the test, at a level above the average human test-taker); write poetry and song lyrics; emulate a Linux system; simulate an entire chat room; play games like tic-tac-toe; and simulate an ATM. ChatGPT training data includes many pages and information about internet phenomena and programming languages, such as bulletin board systems and the Python programming language.

### Exemplary Embodiments

In one aspect, a server computing device may be provided. The computing device may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. The computing device may include at least one processor in communication with at least one memory device and with a user device corresponding to a user. The at least one processor is configured to: (i) receive, from the user device, a transportation request including an origin, a destination, and at least one good or person to be transported; (ii) select, based upon the transportation request using an artificial intelligence (AI) model, an autonomous vehicle (AV) of a plurality of candidate AVs in communication with the server computing device, wherein the AI model is trained using historical transportation records including historical transportation data associated with historical transportation; (iii) generate, based upon the transportation request using the AI model, a route for the AV; and (iv) transmit route data to the selected AV, wherein the route data causes the selected AV to travel the generated route. The computing device may include additional, less, or alternate functionality, including that discussed elsewhere herein.

Another embodiment of the server computing device may include the at least one processor being further configured to, in response to receiving the transportation request, retrieve one or more of geographic data, contextual data, and/or user profile data associated with the transportation request, wherein AV is selected based at least in part upon the geographic data, contextual data, and/or user profile data.

Another embodiment of the server computing device may include the at least one processor being further configured to receive the transportation request as a natural language input, wherein the AI model is configured to interpret the natural language input.

Another embodiment of the server computing device may include the at least one processor being further configured to: (i) receive at least one of telematics data or event data corresponding to a completed transportation request; and (ii) further train the AI model based upon the at least one of the telematics data or the event data.

Another embodiment of the server computing device may include each AV of the plurality of candidate AVs corresponds to an AV type of a plurality of AV types, and wherein the at least one processor is further configured to select an AV type from which to select the AV based upon the at least one good or person to be transported.

Another embodiment of the server computing device may include the at least one processor being further configured to select the AV based upon one or more registered operating parameters that define conditions under which use of an AV for the transportation request is to be automatically declined.

Another embodiment of the server computing device may include the at least one processor being further configured to compute, using the AI model, a total cost associated with using the selected AV.

Another embodiment of the server computing device may include the at least one processor being further configured to compute, using the AI model, an insurance cost associated with the route, the total cost including the insurance cost.

Another embodiment of the server computing device may include the at least one processor being further configured to compute a subscription amount based upon the total cost associated with each transportation request of the user during a period.

Another embodiment of the server computing device may include the at least one processor being further configured to select the AV based at least in part upon the total cost associated with using the selected AV.

The server computing device may include any combination of the above embodiments and/or any other features described herein.

In another aspect, a computer-implemented method for autonomous vehicle (AV) selection and routing may be provided. The computer-implemented method may be performed by a server computing device including at least one processor in communication with at least one memory device and with a user device corresponding to a user. The method includes: (i) receiving, from the user device, a transportation request including an origin, a destination, and at least one good or person to be transported; (ii) selecting, based upon the transportation request using an artificial intelligence (AI) model, an autonomous vehicle (AV) of a plurality of candidate AVs in communication with the server computing device, wherein the AI model is trained using historical transportation records including historical transportation data associated with historical transportation; (iii) generating, based upon the transportation request using the AI model, a route for the AV; and (iv) transmitting route data to the selected AV, wherein the route data causes the selected AV to travel the generated route. The computer-implemented method may include additional, less, or alternate actions, including those discussed elsewhere herein.

Another embodiment of the computer-implemented method may include, in response to receiving the transportation request, retrieving one or more of geographic data, contextual data, and/or user profile data associated with the transportation request, wherein AV is selected based at least in part upon the geographic data, contextual data, and/or user profile data.

Another embodiment of the computer-implemented method may include receiving the transportation request as a natural language input, wherein the AI model is configured to interpret the natural language input.

Another embodiment of the computer-implemented method may include: (i) receiving at least one of telematics data or event data corresponding to a completed transportation request; and (ii) further training the AI model based upon the at least one of the telematics data or the event data.

Another embodiment of the computer-implemented method may include each AV of the plurality of candidate AVs corresponds to an AV type of a plurality of AV types, wherein the computer-implemented method further comprises selecting an AV type from which to select the AV based upon the at least one good or person to be transported.

Another embodiment of the computer-implemented method may include selecting the AV based upon one or more registered operating parameters that define conditions under which use of an AV for the transportation request is to be automatically declined.

Another embodiment of the computer-implemented method may include computing, using the AI model, a total cost associated with using the selected AV.

Another embodiment of the computer-implemented method may include computing, using the AI model, an insurance cost associated with the route, the total cost including the insurance cost.

Another embodiment of the computer-implemented method may include computing a subscription amount based upon the total cost associated with each transportation request of the user during a period.

Another embodiment of the computer-implemented method may include selecting the AV based at least in part upon the total cost associated with using the selected AV.

The method may include any combination of the above embodiments and/or any other features described herein.

In another aspect, at least one non-transitory computer-readable storage media having computer-executable instructions embodied thereon may be provided. When executed by a server computing device including at least one processor in communication with at least one memory device and with a user device corresponding to a user, the computer-executable instructions cause at least one processor to: (i) receive, from the user device, a transportation request including an origin, a destination, and at least one good or person to be transported; (ii) select, based upon the transportation request using an artificial intelligence (AI) model, an autonomous vehicle (AV) of a plurality of candidate AVs in communication with the server computing device, wherein the AI model is trained using historical transportation records including historical transportation data associated with historical transportation; (iii) generate, based upon the transportation request using the AI model, a route for the AV; and (iv) transmit route data to the selected AV, wherein the route data causes the selected AV to travel the generated route. The computer-executable instructions may direct additional, less, or alternate functionality, including that discussed elsewhere herein.

Another embodiment of the at least one non-transitory computer-readable storage media may include the computer-executable instructions causing the at least one processor to, in response to receiving the transportation request, retrieve one or more of geographic data, contextual data, and/or user profile data associated with the transportation request, wherein AV is selected based at least in part upon the geographic data, contextual data, and/or user profile data.

Another embodiment of the at least one non-transitory computer-readable storage media may include the computer-executable instructions causing the at least one processor to receive the transportation request as a natural language input, wherein the AI model is configured to interpret the natural language input.

Another embodiment of the at least one non-transitory computer-readable storage media may include the computer-executable instructions causing the at least one processor to: (i) receive at least one of telematics data or event data corresponding to a completed transportation request; and (ii) further train the AI model based upon the at least one of the telematics data or the event data.

Another embodiment of the at least one non-transitory computer-readable storage media may include each AV of the plurality of candidate AVs corresponds to an AV type of a plurality of AV types, and wherein the computer-executable instructions causing the at least one processor to select an AV type from which to select the AV based upon the at least one good or person to be transported.

Another embodiment of the at least one non-transitory computer-readable storage media may include the computer-executable instructions causing the at least one processor to select the AV based upon one or more registered operating parameters that define conditions under which use of an AV for the transportation request is to be automatically declined.

Another embodiment of the at least one non-transitory computer-readable storage media may include the computer-executable instructions causing the at least one processor to compute, using the AI model, a total cost associated with using the selected AV.

Another embodiment of the at least one non-transitory computer-readable storage media may include the computer-executable instructions causing the at least one processor to compute, using the AI model, an insurance cost associated with the route, the total cost including the insurance cost.

Another embodiment of the at least one non-transitory computer-readable storage media may include the computer-executable instructions causing the at least one processor to compute a subscription amount based upon the total cost associated with each transportation request of the user during a period.

Another embodiment of the at least one non-transitory computer-readable storage media may include the computer-executable instructions causing the at least one processor to select the AV based at least in part upon the total cost associated with using the selected AV.

The non-transitory computer-readable storage media may include any combination of the above embodiments and/or any other features described herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A server computing device comprising at least one processor, and at least one memory device in communication with the at least one processor, the at least one processor is further communication with a user device corresponding to a user, the at least one processor configured to:
receive, from the user device, a transportation request including an origin, a destination, and at least one good or person to be transported;
select, based upon the transportation request using an artificial intelligence (AI) model, an autonomous vehicle (AV) of a plurality of candidate AVs in communication with the server computing device, wherein the AI model is trained using historical transportation records including historical transportation data associated with historical transportation;
generate, based upon the transportation request using the AI model, a route for the AV; and
transmit route data to the selected AV, wherein the route data causes the selected AV to travel the generated route.

2. The server computing device of claim 1, wherein the at least one processor is further configured to, in response to receiving the transportation request, retrieve one or more of geographic data, contextual data, and/or user profile data associated with the transportation request, wherein AV is selected based at least in part upon the geographic data, contextual data, and/or user profile data.

3. The server computing device of claim 1, wherein the at least one processor is further configured to receive the transportation request as a natural language input, wherein the AI model is configured to interpret the natural language input.

4. The server computing device of claim 1, wherein the at least one processor is further configured to:
receive at least one of telematics data or event data corresponding to a completed transportation request; and
further train the AI model based upon the at least one of the telematics data or the event data.

5. The server computing device of claim 1, wherein each AV of the plurality of candidate AVs corresponds to an AV type of a plurality of AV types, and wherein the at least one processor is further configured to select an AV type from which to select the AV based upon the at least one good or person to be transported.

6. The server computing device of claim 1, wherein the at least one processor is further configured to select the AV based upon one or more registered operating parameters that define conditions under which use of an AV for the transportation request is to be automatically declined.

7. The server computing device of claim 1, wherein the at least one processor is further configured to compute, using the AI model, a total cost associated with using the selected AV.

8. The server computing device of claim 7, wherein the at least one processor is further configured to compute, using the AI model, an insurance cost associated with the route, the total cost including the insurance cost.

9. The server computing device of claim 7, wherein the at least one processor is further configured to compute a subscription amount based upon the total cost associated with each transportation request of the user during a period.

10. The server computing device of claim 7, wherein the at least one processor is further configured to select the AV based at least in part upon the total cost associated with using the selected AV.

11. A computer-implemented method for autonomous vehicle (AV) selection and routing performed by a server computing device including at least one processor in communication with at least one memory device and with a user device corresponding to a user, the method comprising:
receiving, from the user device, a transportation request including an origin, a destination, and at least one good or person to be transported;
selecting, based upon the transportation request using an artificial intelligence (AI) model, an autonomous vehicle (AV) of a plurality of candidate AVs in communication with the server computing device, wherein the AI model is trained using historical transportation records including historical transportation data associated with historical transportation;
generating, based upon the transportation request using the AI model, a route for the AV; and
transmitting route data to the selected AV, wherein the route data causes the selected AV to travel the generated route.

12. The computer-implemented method of claim 11, further comprising, in response to receiving the transportation request, retrieving one or more of geographic data, contextual data, and/or user profile data associated with the transportation request, wherein AV is selected based at least in part upon the geographic data, contextual data, and/or user profile data.

13. The computer-implemented method of claim 11, further comprising receiving the transportation request as a natural language input, wherein the AI model is configured to interpret the natural language input.

14. The computer-implemented method of claim 11, further comprising:
receiving at least one of telematics data or event data corresponding to a completed transportation request; and
further training the AI model based upon the at least one of the telematics data or the event data.

15. The computer-implemented method of claim 11, wherein each AV of the plurality of candidate AVs corresponds to an AV type of a plurality of AV types, wherein the computer-implemented method further comprises selecting an AV type from which to select the AV based upon the at least one good or person to be transported.

16. The computer-implemented method of claim 11, further comprising selecting the AV based upon one or more registered operating parameters that define conditions under which use of an AV for the transportation request is to be automatically declined.

17. The computer-implemented method of claim 11, further comprising computing, using the AI model, a total cost associated with using the selected AV.

18. The computer-implemented method of claim 17, further comprising computing, using the AI model, an insurance cost associated with the route, the total cost including the insurance cost.

19. The computer-implemented method of claim 17, further comprising computing a subscription amount based upon the total cost associated with each transportation request of the user during a period.

20. The computer-implemented method of claim 18, further comprising selecting the AV based at least in part upon the total cost associated with using the selected AV.

21. At least one non-transitory computer-readable storage media having computer-executable instructions embodied thereon, wherein when executed by a computing device including at least one processor in communication with at least one memory device and with a user device corresponding to a user, the computer-executable instructions cause at least one processor to:
receive, from the user device, a transportation request including an origin, a destination, and at least one good or person to be transported;
select, based upon the transportation request using an artificial intelligence (AI) model, an autonomous vehicle (AV) of a plurality of candidate AVs in communication with the server computing device, wherein the AI model is trained using historical transportation records including historical transportation data associated with historical transportation;
generate, based upon the transportation request using the AI model, a route for the AV; and
transmit route data to the selected AV, wherein the route data causes the selected AV to travel the generated route.
